(19) United States
(12) Patent Application Publication
(10) Pub. No.: US 2022/0033698 A1
(43) Pub. Date: Feb. 3, 2022

(54) ADHESIVE

(71) Applicant: DOW SILICONES CORPORATION, Midland, MI (US)

(72) Inventors: Yi GUO, Shanghai (CN); Jiang PENG, Shanghai (CN); Qiang SONG, Shanghai (CN); Ye WU, Shanghai (CN)

(21) Appl. No.: 17/288,513

(22) PCT Filed: Oct. 31, 2018
(86) PCT No.: PCT/CN2018/112856

§ 371 Date: Apr. 23, 2021

(51) Int. Cl. C09J 183/06; C09J 171/00; C09J 175/04; C09J 133/08; C09J 11/04; G02B 1/04

(52) U.S. Cl. CPC C09J 183/06; C09J 171/00; C09J 175/04; C09J 133/08; C09J 11/04; F21V 5/00; C09J 2483/00; C09J 2471/00; C09J 2433/00; C09J 2475/00; G02B 1/041

(57) ABSTRACT

Described herein is a two-part condensation curable silyl-modified polymer based adhesive composition suitable for the adhesion of a front lens having an anti-haze coating onto a lamp body for lighting applications. Also described herein are lamps comprising a lamp body and a front lens utilizing the adhesive composition to adhere the front lens to the lamp body while generally preserving the integrity of the anti-haze coating.

### CROSS-REFERENCE TO RELATED APPLICATIONS

This application is the National Stage of, and claims priority to and all advantages of, International Appl. No. PCT/CN2018/112856 filed on 31 Oct. 2018, the content of which is hereby incorporated by reference.

### TECHNICAL FIELD

This disclosure is concerned with the provision of condensation curable silyl-modified polymer (SMP) based adhesives for use in particular, in the adhesion of a front lens onto a lamp body for lighting applications and to lamps comprising a lamp body and a front lens utilising said adhesives to adhere said lens to the lamp body.

### BACKGROUND

Condensation curable SMP based adhesives are utilised in a variety of lighting and window applications. For the sake of example they may be used as adhesives for anti-fog windows; lenses for lighting applications and/or transparent covers for lighting applications such as automotive lighting, street lighting, outdoor lighting. Particularly important are their use in “high efficiency” lighting systems such as light emitting diode (LED) applications, organic LED applications, fluorescent lighting applications, vapor gas discharge lighting applications, and neon light applications.

One of the characteristics of high efficiency lighting applications is that they produce less heat than conventional light sources. These high efficiency lighting systems are often provided in enclosed housings. Lighting units e.g. vehicle headlamps often comprise a lamp body that defines a lamp chamber and has a front opening and a front lens which is designed to fit and engage the front opening and which is sealed in place with an adhesive e.g. a condensation curable organosiloxane based adhesive. A discharge lamp bulb located within the lamp chamber acts as a light source.

The front lens is typically transparent and may be made from a variety of materials, such as polymethylmethacrylate (PMMA) or polycarbonate resins. Such resins may be molded, extruded and/or thermoformed to make e.g. front lenses for lighting units and can improve the overall transparency and transmission of the lighting system. However, products made from polycarbonates and other resins suitable for making these lenses typically have hydrophobic surfaces. The hydrophobic nature of these surfaces when used as transparent front covers in sealed lighting units e.g. in LED systems, as well as other lower heat emitting light appliances can prove problematic when e.g. polycarbonate material is used for its optical qualities, high refractive index (RI) and/or optical clarity. This is because of the susceptibility to the accumulation of moisture/water droplets/particles on the surface of the resin which reduces the transparency and/or transmission of visible light through the material, particularly when accumulated on the inner surface of the transparent front cover in a sealed lighting unit such as a headlamp which is referred to in the industry as cold fogging or cold hazing.

Unfortunately, whilst saving energy, a side effect of the introduction of the highly efficient lighting systems is that, as previously indicated they generate less heat and therefore accumulated moisture on the surface of these lighting systems is less likely to evaporate during use. The aforementioned accumulation of moisture, etc., on the inner surface of transparent covers of the light units is referred to in the industry as “fogging” or “hazing”. These terms are effectively interchangeable but henceforth will be referred to as hazing.

Assuming the front lens of a head lamp is made from a material having hydrophobic surfaces such as a polycarbonate resin (PC) the inner surface of the front lens is hydrophobic and is sealed into the lamp body. Automotive headlamps are not however, hermitically sealed but may have openings for pressure equilibration. These openings are sealed with membranes which let environmental air and humidity move in and out of the headlamp. Under specific environmental conditions (e.g. cold but high humidity), the humidity inside the headlamp can condense on the inner hydrophobic surface of the front lens in the form of very fine droplets which gives the appearance of a hazy film (or fog) from the outside resulting in reduced quality of lighting emanating from the lamp through the front lens.

Several solutions for overcoming this hazing or fogging issue have been developed. Perhaps the most common is the application of anti-haze-coatings (AHCs) onto the inner surface of the front lens. An AHC, once applied to the inner surface of a lens, creates a hydrophilic surface coating thereon so that whilst condensation on the surface may still occur the water is able to form a thin film which is no longer visible by end-users. However, when headlamps with an AHC coated inner surface of the lens are sealed with standard silicone adhesives, the hydrophilic nature of the AHC is destroyed after a short period of time due to outgassing and volatiles released into the lamp chamber from the silicone adhesives which may to interact with the AHC.

A wide range of ingredients can be incorporated into such commercial hydrophilic anti-fogging/anti-haze coating compositions which are designed to maximize the surface energy of the inner surface of such front covers. These may include hydrophilic organic substances including for example methylmethacrylate, diethyleneglycol-monomethyl ether methacrylate as well as hydrogels and gelatin.

Another solution is the introduction of anti-haze additives e.g. surfactants into the resins themselves during manufacture of the lenses. These are intended to function in a similar way to the coatings but without the need for application of such a coating on the inner surface of the lens, i.e. to provide a hydrophilic surface thereby preventing said inner surface of the lens from being subjected to the mist, condensation or other forms of hazing.

These additives include sorbitan esters, ethoxylated sorbitan esters, polyol esters and glycerol esters. Such additives have been successfully introduced into e.g. polyethylene and poly (vinyl chloride) material used in some fog resistant articles and avoiding the need for anti-haze coatings. However, they have been found to be generally unsuitable for use in polycarbonate and aromatic thermoplastic polymers.

Consequently, such transparent polymeric surfaces are often treated with one or more coatings to provide anti-fog performance, and scratch or abrasion resistance. Lens coatings can be applied in different ways, such as, for example, using a dip coating process or a spin coating process. Multiple coatings may also be necessary to obtain other properties such as a mirror coating, and stain and smudge resistance.

As previously described, the transparent front lenses for lighting units are generally designed to fit and engage into the front opening of a lamp chamber and are sealed in place using adhesives to form a sealed unit. Given their physical characteristics condensation cured silicone based adhesives are one of the most preferred adhesives for this application. Whilst these are excellent in the role of adhesive, the condensation cure mechanism and preferred choice of cross-linkers to cause cure will produce chemical by-products during the cure process inside the sealed unit.

The composition typically includes an —OH terminated polydimethylsiloxane polymer, a cross-linker such as methyl trimethoxysilane (having reactive methoxy groups which interact with —OH groups from the polydimethylsiloxane polymer to generate methanol as a by-product during the cure process. It has been found that condensation by-products and residual cross-linker material is often deposited on the AHC treated inner surface of the front lens and this deposition onto the anti-haze coating provided diminishes the effectiveness of the anti-haze coating or may even prevent it from functioning completely resulting with a gradual increase of hazing on the inner surface of the front cover. Similarly for systems where additives are introduced intro the polymer/resin materials during production, deposition of the cure by-products diminished or prevent the anti-haze function which again results in a gradual increase of hazing on the inner surface of the front cover. It has also been identified that some of the adhesion promoters used in assisting adhesion of the above silicone adhesives may also negatively affect the function of anti-haze coatings especially those which are volatile.

It can therefore be appreciated that whilst condensation cure adhesives are one of the most preferred and suitable adhesives for sealing a front lens, pre-coated with an AHC coating, into a lamp body, the resulting deposition of cure by-products and residual cross-linkers on the surface of anti-haze coatings or surfaces renders the combined use of these materials to be problematic because of the resulting hazing caused by the deposition of the condensation cure by-products.

The disclosure herein seeks to provide a suitable alternative condensation curable SMP based adhesive composition, which upon cure does not minimise or prevent the functioning of an anti-haze treated material surface.

### SUMMARY

There is provided herein a two-part condensation curable silyl modified polymer (SMP) based adhesive composition comprising a base part, Part A, which comprises

(a) a silyl modified organic polymer having at least two (R)ₘ(Y¹)₃₋ₘ— Si groups per molecule
where each R is hydroxyl or a hydrolysable group, each Y¹ is an alkyl group containing from 1 to 8 carbons and m is 1, 2 or 3, which organic polymer is selected from polyethers, hydrocarbon polymers, acrylate polymers, polyesters, polyurethanes and polyureas;
and
(b) a reinforcing filler
and
   a catalyst package, Part B comprising
(i) a condensation cure catalyst; and
(ii) a cross-linker selected from the group of:—
   (iia) a silane of the structure

R⁶ⱼSi(OR⁵)₄₋ⱼ

where each R⁵ may be the same or different and is an alkyl group containing at least 2 carbon atoms;
j is 1 or 0; and
R⁶ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group;
(iib) a silane of the structure

R⁷Si(OMe)₃

wherein R⁷ is R⁶ providing the molecular weight of said silane (iib) is ≥190;
(iic) a silane of the structure

(R′O)₃Si(CH₂)ₙN(H)—(CH₂)_{z}NH₂

in which each R′ may be the same or different and is an alkyl group containing from 1 to 10 carbon atoms, n is from 2 to 10 and z is from 2 to 10; or
(iid) a dipodal silane of the of the structure

(R⁴O)ᵣ(Y²)₃₋ᵣ—Si(CH₂)ₓ—((NHCH₂CH₂)ₜ-Q(CH₂)ₓ)_{w}—Si(OR⁴)ᵣ(Y²)₃₋ᵣ
where R⁴ is a C₁₋₁₀ alkyl group, Y2 is an alkyl groups containing from 1 to 8 carbons,
Q is a chemical group containing a heteroatom with a lone pair of electrons; each x is an integer of from 1 to 6, t is 0 or 1; each r is independently 1, 2 or 3 and w is 0 or 1; or (iie) a mixture of two or more of (iia), (iib), (iic) and (iid); and optionally
(iii) silyl modified organic polymer having at least two (R)ₘ(Y¹)₃₋ₘ— Si groups per molecule (a) and/or
(iv) filler.

There is also provided a lamp having a lamp body defining a lamp chamber containing a light source and having a front opening, a front lens is provided to fit and engage into the front opening, said front lens having an inner surface and an outer surface, with said inner surface further defining the lamp chamber, the inner surface being coated with an anti-haze coating characterised in that the front lens is adhered to the lamp chamber by a cured adhesive made from the composition as herein before described.

Furthermore, there is provided a method for making the aforementioned lamp including the steps of including the steps of providing a lamp body having a front opening and a front lens, said front lens having at least an inner surface treated with an anti-haze coating, forming a joint between the front lens into the front opening of the lamp body by engaging the front lens into the front opening of the lamp body and sealing the joint between the front lens and the lamp body with adhesive as hereinbefore described by mixing part A and part B of the composition together to form a mixture, applying the mixture onto the joint between the front lens and the lamp body and causing or allowing the composition to cure.

There is also provided herein the use of an adhesive composition as described herein as an adhesive for adhering a front lens of a lamp, treated with an anti-haze coating, to a lamp body whilst minimising or avoiding the generation of species which inhibit the function of the anti-haze coating.

### DETAILED DESCRIPTION

The concept of “comprising” where used herein is used in its widest sense to mean and to encompass the notions of “include” and “consist of”.

For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

The base component comprises (a) a silyl modified organic polymer having at least two (R)ₘ(Y¹)₃₋ₘ—Si groups per molecule where each R is hydroxyl or a hydrolysable group, each Y¹ is an alkyl group containing from 1 to 8 carbons and m is 1, 2 or 3, which organic polymer is selected from polyethers, hydrocarbon polymers, acrylate polymers, polyurethanes and polyureas.

The (R)ₘ(Y¹)₃₋ₘ—Si groups may be linked to the organic polymer backbone via any suitable linkage or may be directly bonded where appropriate. For example in the case of silyl modified polyether polymers (R)ₘ(Y¹)₃₋ₘ—Si groups may be terminal groups linked to the polyether polymer backbone via the following

(R)ₘ(Y¹)₃₋ₘ—Si-D-[NH—C(═O)]ₖ—

Where R, Y¹ and m are as hereinbefore described D is a divalent C₂₋₆ alkylene group, alternatively a C₂₋₄ alkylene group, alternatively an ethylene or propylene group and k is 1 or 0. So a silyl modified polyether might be depicted as

(R)ₘ(Y¹)₃₋ₘ—Si-D-[NH—C(═O)]ₖ—O[CH(CH₃)—CH₂—O]ᵤ—[C(═O)—NH]ₖ-D-Si(Y¹)₃₋ₘ(R)ₘ

Wherein in the above example the polyether repeating group, for the sake of example, is an oxypropylene group [CH(CH₃)—CH₂—O].

Each substituent R in an (R)ₘ(Y¹)₃₋ₘ—Si group may independently be a hydroxyl group or a hydrolysable group. The hydrolysable groups may be selected from acyloxy groups (for example, acetoxy, octanoyloxy, and benzoyloxy groups); ketoximino groups (for example dimethyl ketoximo, and isobutylketoximino); alkoxy groups (for example methoxy, ethoxy and propoxy) and alkenyloxy groups (for example isopropenyloxy and 1-ethyl-2-methylvinyloxy). However, it is preferred that each R is an OH group or an alkoxy group having from 1 to 10 carbons, alternatively an OH group or an alkoxy group having from 1 to 6 carbons, alternatively an OH group, a methoxy group or a ethoxy group. Substituent Y¹ is an alkyl group containing from 1 to 8 carbons, alternatively 1 to 6 carbons, alternatively 1 to 4 carbons. Hence, when R is OH or a hydrolysable group and the hydrolysable group is an alkoxy group, the (R)ₘ(Y¹)₃₋ₘ—Si groups may be selected from —(Y¹)SiOH₂, —(Y¹)₂SiOH, —Y¹Si(OR^{b})₂, —Si(OR^{b})₃, —(Y¹)₂SiOR^{b} with R^{b} being an alkyl group having from 1 to 8 carbons. Typically, the silyl modified organic polymer has an organic backbone having terminal curable silyl groups.

One preferred type of polymer backbone is an acrylate polymer backbone. The acrylate polymer is an addition polymerised polymer of acrylate and/or methacrylate ester monomers, which comprise at least 50%, (i.e. from 50% to 100%) by weight of the monomer units in the acrylate polymer. Examples of acrylate ester monomers are n-butyl, isobutyl, n-propyl, ethyl, methyl, n-hexyl, n-octyl and 2-ethylhexyl acrylates. Examples of methacrylate ester monomers are n-butyl, isobutyl, methyl, n-hexyl, n-octyl, 2-ethylhexyl and lauryl methacrylates. The acrylate polymer preferably has a glass transition temperature (Tg) below ambient temperature; acrylate polymers are generally preferred over methacrylates since they form lower Tg polymers. Polybutyl acrylate is particularly preferred. The acrylate polymer can contain lesser amounts of other monomers such as styrene, acrylonitrile or acrylamide. The acrylate(s) can be polymerized by various methods such as conventional radical polymerization, or living radical polymerization such as atom transfer radical polymerization, reversible addition-fragmentation chain transfer polymerization, or anionic polymerization including living anionic polymerisation.

In one alternative the alkoxy silyl terminated organic polymer is a polyether as previously described. Whereas the polymer backbone is exemplified in the structure above as

[CH(CH₃)—CH₂—O]ᵤ

such polyethers may comprise a variety of recurring oxyalkylene units, illustrated by the average formula (—CₚH₂ₚ—O—)_{y} wherein p is an integer from 2 to 4 inclusive and y is an integer ≥4 i.e. of at least four. The number average molecular weight (Mn) of each polyether may range from about 300 to about 10,000 which may be determined by way of ASTM D5296-05 and calculated as polystyrene molecular weight equivalents. Moreover, the oxyalkylene units are not necessarily identical throughout the polyoxyalkylene, but can differ from unit to unit. A polyoxyalkylene, for example, can comprise oxyethylene units (—C₂H₄—O—), oxypropylene units (—C₃H₆—O—) or oxybutylene units (—C₄H₈—O—), or mixtures thereof. Preferably the polyoxyalkylene polymeric backbone consists essentially of oxyethylene units or oxypropylene units. Other polyoxyalkylenes may include for example: units of the structure:

—[R^{e}—O—(—R^{f}—O—)ₕ-Pn-CR^{g}₂-Pn-O—(—R^{f}—O—)_{q1}—R^{E}]—

in which Pn is a 1,4-phenylene group, each R^{e} is the same or different and is a divalent hydrocarbon group having 2 to 8 carbon atoms, each R^{f} is the same or different and is an ethylene group or propylene group, each R^{g} is the same or different and is a hydrogen atom or methyl group and each of the subscripts h and q1 is a positive integer in the range from 3 to 30.

One preferred type of polyether is a polyoxyalkylene polymer comprising recurring oxyalkylene units of the formula (—CₚH₂ₚ—O—) wherein p is an integer from 2 to 4 inclusive. Polyoxyalkylenes usually have terminal hydroxyl groups and can readily be modified with moisture curable silyl groups, for example by reaction with an excess of an alkyltrialkoxysilane to introduce terminal alkyldialkoxysilyl groups as previously discussed. Alternatively polymerization may occur via a hydrosilylation type process. Polyoxyalkylenes consisting wholly or mainly of oxypropylene units have properties suitable for many adhesion uses.

Examples of silyl modified hydrocarbon polymers include silyl modified polyisobutylene. Silyl modified polyisobutylene can for example contain curable silyl groups derived from a silyl-substituted alkyl acrylate or methacrylate monomer such as alkoxydialkylsilylpropyl methacrylate, dialkoxyalkylsilylpropyl methacrylate or trialkoxysilylpropyl methacrylate, which can be reacted with a polyisobutylene.

Typically, the SMP polymer is present in the base composition in an amount of from 30 to 80% by weight of the base composition, alternatively from 35 to 65% by weight of the base composition, alternatively from 40 to 60% by weight of the base composition.

The base component reinforcing filler (b) may contain one or more finely divided, reinforcing fillers such as precipitated calcium carbonate, fumed silica and/or precipitated silica including, for example, rice hull ash. Typically, the surface area of the reinforcing filler (b) is at least 15 m²/g in the case of precipitated calcium carbonate measured in accordance with the BET method in accordance with ISO 9277: 2010, alternatively 15 to 50 m²/g, alternatively 15 to 25 m²/g in the case of precipitated calcium carbonate. Silica reinforcing fillers have a typical surface area of at least 50 m²/g. In one embodiment reinforcing filler (b) is a precipitated calcium carbonate, precipitated silica and/or fumed silica; alternatively precipitated calcium carbonate. In the case of high surface area fumed silica and/or high surface area precipitated silica, these may have surface areas of from 100 to 400 m²/g measured in accordance with the BET method in accordance with ISO 9277: 2010, alternatively of from 100 to 300 m²/g in accordance with the BET method in accordance with ISO 9277: 2010, may be chosen for use. Typically, the reinforcing fillers are present in the base composition in an amount of from 20 to 70% by weight of the base composition, alternatively from 35 to 65% by weight of the base composition, alternatively from 40 to 60% by weight of the base composition.

Reinforcing filler (b) may be hydrophobically treated for example with one or more aliphatic acids, e.g. a fatty acid such as stearic acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other adhesive components. The surface treatment of the fillers makes them easily wetted by siloxane polymer (a) of the base component. These surface modified fillers do not clump, and can be homogeneously incorporated into the silicone polymer (a) of the base component. This results in improved room temperature mechanical properties of the uncured compositions. The fillers may be pre-treated or may be treated in situ when being mixed with polymer (a).

As hereinbefore described the catalyst package of the two component composition comprises a catalyst package, Part B comprising
(i) a condensation cure catalyst, and
(ii) a cross-linker selected from the group of:
   a silane of the structure (iia)

R⁶ⱼSi(OR⁵)₄₋ⱼ

where each R⁵ may be the same or different and is an alkyl group containing at least 2 carbon atoms;
j is 1 or 0; and
R⁶ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group;
A silane of the structure (iib)

R⁷Si(OMe)₃

wherein R⁷ is R⁶ providing the molecular weight of said silane (iib) is ≥190;

(iic) (R′O)₃Si(CH₂)ₙN(H)—(CH₂)_{z}NH₂
in which each R′ may be the same or different and is an alkyl group containing from 1 to 10 carbon atoms, n is from 2 to 10 and z is from 2 to 10;
(iid) a dipodal silane of the of the structure

(R⁴O)ᵣ(Y²)₃₋ᵣ—Si(CH₂)ₓ—((NHCH₂CH₂)ₜ-Q(CH₂)ₓ)_{w}—Si(OR⁴)ᵣ(Y²)₃₋ᵣ

where R⁴ is a C1-10 alkyl group, Y² is an alkyl group containing from 1 to 8 carbons,

Q is a chemical group containing a heteroatom with a lone pair of electrons; each x is an integer of from 1 to 6, t is 0 or 1; each r is independently 1, 2 or 3 and w is 0 or 1, or
(iie) a mixture of two or more of (iia), (iib) (iic) and (iid); and optionally
(iii) silyl modified organic polymer having at least two (R)ₘ(Y¹)₃₋ₘ— Si groups per molecule (a) and/or
(iv) filler.

The condensation cure catalyst (i) may be any suitable tin based condensation catalyst (i) suitable for catalysing the cure of the total composition subsequent to mixing the base component and catalyst package component together. Examples include tin triflates, organic tin metal catalysts such as triethyltin tartrate, tin octoate, tin oleate, tin naphthate, butyltintri-2-ethylhexoate, tin butyrate, carbomethoxyphenyl tin trisuberate, isobutyltintriceroate, and diorganotin salts especially diorganotin dicarboxylate compounds such as dibutyltin dilaurate, dimethyltin dibutyrate, dibutyltin dimethoxide, dibutyltin diacetate, dimethyltin bisneodecanoate, dibutyltin dibenzoate, stannous octoate, dibutyltin bis(2,4-pentanedionate, dimethyltin dineodecanoate (DMTDN) and dibutyltin dioctoate.

Alternatively, the condensation catalyst (i) may be a titanium or zirconium based catalyst. The catalyst chosen for inclusion in a particular silicone sealant composition depends upon the speed of cure required. Titanate and/or zirconate based catalysts may comprise a compound according to the general formula Ti[OR⁹]₄ or Zr[OR⁹]₄ where each R⁹ may be the same or different and represents a monovalent, primary, secondary or tertiary aliphatic hydrocarbon group which may be linear or branched containing from 1 to 10 carbon atoms. Optionally the titanate may contain partially unsaturated groups. However, preferred examples of R⁹ include but are not restricted to methyl, ethyl, propyl, isopropyl, butyl, tertiary butyl and a branched secondary alkyl group such as 2, 4-dimethyl-3-pentyl. Preferably, when each R⁹ is the same, R⁹ is an isopropyl, branched secondary alkyl group or a tertiary alkyl group, in particular, tertiary butyl. Suitable examples include for the sake of example, tetra n-butyl titanate, tetra t-butyl titanate, tetra t-butoxy titanate, tetraisopropoxy titanate and diisopropoxydiethylacetoacetate titanate (as well as zirconate equivalents). Alternatively, the titanate/zircinate may be chelated. The chelation may be with any suitable chelating agent such as an alkyl acetylacetonate such as methyl or ethylacetylacetonate. Alternatively, the titanate may be monoalkoxy titanates bearing three chelating agents such as for example 2-propanolato, tris isooctadecanoato titanate.

The catalyst package also contains a cross-linker (ii). Cross-linker (ii) may be selected from silane (iia) having the structure

R⁶ⱼSi(OR⁵)₄₋ⱼ

where each R⁵ may be the same or different and is an alkyl group containing at least two carbons, alternatively from 2 to 20 carbons, alternatively from 2 to 10 carbons alternatively from 2 to 6 carbons. The value of j is 0 or 1. Whilst each R⁵ group may be the same of different it is preferred that at least two R⁵ groups are the same, alternatively at least three R⁵ groups are the same and alternatively when j is 0 all R⁵ groups are the same. Hence, specific examples of cross-linker (iia) when j is zero include tetraethylorthosilicate, tetrapropylorthosilicate, tetra(n-)butylorthosilicate and tetra(t-)butylorthosilicate.

When j is 1 the group R⁶ is present. R⁶ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group an iocyanurate group or an isocyanate group. Unsubstituted monovalent hydrocarbon groups, suitable as R⁶, may include alkyl groups e.g. ethyl, propyl, and other alkyl groups, alkenyl groups, cycloalkyl groups may include cyclopentane groups and cyclohexane groups. Substituted groups suitable in or as R⁶, may include, for the sake of example, 3-hydroxypropyl groups, 3-(2-hydroxyethoxy)alkyl groups, halopropyl groups, 3-mercaptopropyl groups, trifluoroalkyl groups such as 3,3,3-trifluoropropyl, 2,3-epoxypropyl groups, 3,4-epoxybutyl groups, 4,5-epoxypentyl groups, 2-glycidoxyethyl groups, 3-glycidoxypropyl groups, 4-glycidoxybutyl groups, 2-(3,4-epoxycyclohexyl) ethyl groups, 3-(3,4-epoxycyclohexyl)alkyl groups, aminopropyl groups, N-methylaminopropyl groups, N-butylaminopropyl groups, N,N-dibutylaminopropyl groups, 3-(2-aminoethoxy)propyl groups, methacryloxyalkyl groups, acryloxyalkyl groups, carboxyalkyl groups such as 3-carboxypropyl groups, 10-carboxydecyl groups.

Specific examples of suitable cross-linkers (iia) include but are not limited to ethyltriethoxysilane, propyltriethoxysilane, isobutyltriethoxysilane, an vinyltriethoxysilane, phenyltriethoxysilane, methyltris(isopropenoxy)silane or vinyltris(isopropenoxy)silane, 3-hydroxypropyl triethoxysilane, 3-(2-hydroxyethoxy)ethyltriethoxysilane, chloropropyl triethoxysilane, 3-mercaptopropyl triethoxysilane, 3,3,3-trifluoropropyl triethoxysilane, 2,3-epoxypropyl triethoxysilane, 3,4-epoxybutyl triethoxysilane, 4,5-epoxypentyl triethoxysilane, 2-glycidoxyethyl triethoxysilane, 3-glycidoxypropyl triethoxysilane, 4-glycidoxybutyl triethoxysilane, 2-(3,4-epoxycyclohexyl) ethyl triethoxysilane, 3-(3,4-epoxycyclohexyl)ethyl triethoxysilane, aminopropyl triethoxysilane, N-methylaminopropyl triethoxysilane, N-butylaminopropyl triethoxysilane, N,N-dibutylaminopropyl triethoxysilane, 3-(2-aminoethoxy)propyl triethoxysilane, methacryloxypropyl triethoxysilane, tris(3-triethoxysilylpropyl) isocyanurate, acryloxypropyl triethoxysilane, 3-carboxypropyl triethoxysilane and 10-carboxydecyl triethoxysilane.

The cross-linker (ii) may additionally or alternatively comprise a compound of the of the structure (iib)

R⁷Si(OMe)₃

wherein R⁷ is R⁶ providing the molecular weight of said silane (iib) is ≥190.

R⁷ may therefore also be a silicon-bonded organic group selected from the following list providing the molecular weight thereof is ≥190. Hence, it may be a substituted or unsubstituted straight or branched monovalent hydrocarbon group having at least 5 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group. Unsubstituted monovalent hydrocarbon groups, suitable as R⁶, may include alkyl groups having at least 5 carbons e.g. pentyl, hexyl and other longer chain alkyl groups, alkenyl groups having at least 5 carbons, cycloalkyl groups may include cyclopentane groups and cyclohexane groups. Substituted groups suitable in or as R⁶, may include, for the sake of example, 3-(2-hydroxyethoxy)alkyl groups, halopropyl groups, 3-mercaptopropyl groups, trifluoroalkyl groups such as 3,3,3-trifluoropropyl, 2,3-epoxypropyl groups, 3,4-epoxybutyl groups, 4,5-epoxypentyl groups, 2-glycidoxyethyl groups, 3-glycidoxypropyl groups, 4-glycidoxybutyl groups, 2-(3,4-epoxycyclohexyl) ethyl groups, 3-(3,4-epoxycyclohexyl)alkyl groups, aminopropyl groups, N-methylaminopropyl groups, N-butylaminopropyl groups, N,N-dibutylaminopropyl groups, 3-(2-aminoethoxy)propyl groups, isocyanurate groups, methacryloxyalkyl groups, acryloxyalkyl groups, carboxyalkyl groups such as 3-carboxypropyl groups, 10-carboxydecyl groups.

Specific examples of suitable cross-linkers (iib) include but are not limited to pentyltrimethoxysilane, hexyltrimethoxysilane, an hexenyltrimethoxysilane, phenyltrimethoxysilane, 3-(2-hydroxyethoxy)ethyltrimethoxysilane, chloropropyl trimethoxysilane, 3-mercaptopropyl trimethoxysilane, 3,3,3-trifluoropropyl trimethoxysilane, 2,3-epoxypropyl trimethoxysilane, 3,4-epoxybutyl trimethoxysilane, 4,5-epoxypentyl trimethoxysilane, 2-glycidoxyethyl trimethoxysilane, 3-glycidoxypropyl trimethoxysilane, 4-glycidoxybutyl trimethoxysilane, 2-(3,4-epoxycyclohexyl) ethyl trimethoxysilane, 3-(3,4-epoxycyclohexyl)ethyl trimethoxysilane, N-methylaminopropyl trimethoxysilane, N-butylaminopropyl trimethoxysilane, N,N-dibutylaminopropyl trimethoxysilane, 3-(2-aminoethoxy)propyl trimethoxysilane, methacryloxypropyl trimethoxysilane, acryloxypropyl trimethoxysilane, tris(3-trimethoxysilylpropyl) isocyanurate, 3-carboxypropyl trimethoxysilane and 10-carboxydecyl trimethoxysilane.

The cross-linker (ii) may additionally or alternatively comprise a compound of the of the structure (iic)

(R′O)₃Si(CH₂)ₙN(H)—(CH₂)_{z}NH₂

in which each R′ may be the same or different and is an alkyl group containing from 1 to 10 carbon atoms, n is from 2 to 10 and z is from 2 to 10. Each R′ may be the same or different and is an alkyl group containing from 1 to 10 carbon atoms, alternatively an alkyl group containing from 1 to 6 carbon atoms, alternatively from 1 to 4 carbon atoms, alternatively is a methyl or ethyl group. In one alternative at least two R′ groups are the same, alternatively all R′ groups are the same. When at least two R′ groups alternatively all R′ groups are the same, it is preferred if they are methyl or ethyl groups. In one alternative there may be n —CH₂— groups where n is from 2 to 10, in one alterative n may be from 2 to 6, in another alternative n may be from 2 to 5, in a still further alternative n may be 2 or 3, alternatively n is 3. There may be z —CH₂— groups where z is from 2 to 10, in one alterative z may be from 2 to 6, in another alternative z may be from 2 to 5, in a still further alternative z may be 2 or 3, alternatively z is 2. Specific examples include but are not limited to (ethylenediaminepropyl) trimethoxysilane and (ethylenediaminepropyl) triethoxysilane.

The cross-linker (ii) may additionally or alternatively comprise a dipodal silane (iid) of the of the structure

(R⁴O)ᵣ(Y²)₃₋ᵣ—Si(CH₂)ₓ—((NHCH₂CH₂)ₜ-Q(CH₂)ₓ)_{w}—Si(OR⁴)ᵣ(Y²)₃₋ᵣ

where R⁴ is a C₁₋₁₀ alkyl group, Y² is an alkyl groups containing from 1 to 8 carbons,

Q is a chemical group containing a heteroatom with a lone pair of electrons; each x is an integer of from 1 to 6, t is 0 or 1; each r is independently 1, 2 or 3 and w is 0 or 1.

Examples of dipodal Silane (iid) include when w=0 are bis(trimethoxy silyl)hexane and bis(trimethoxy silyl) hexane.

When w=1 the dipodal silane (iid) of the catalyst package can be defined by the following formula:

(R⁴O)ᵣ(Y²)₃₋ᵣ—Si(CH₂)ₓ—(NHCH₂CH₂)ₜ-Q(CH₂)ₓ—Si(OR⁴)ᵣ(Y²)₃₋ᵣ

where R⁴ is a C₁₋₁₀ alkyl group, Y² is an alkyl groups containing from 1 to 8 carbons, Q is a chemical group containing a heteroatom with a lone pair of electrons, alternatively an amine or a urea; each x is an integer of from 1 to 6, t is 0 or 1; each r is independently 1, 2 or 3, alternatively 2 or 3, in a further alternative r=3.

In one alternative Q is a secondary amine and each x is from 2 to 4.

Examples of dipodal Silane (iid) include when w=1 include: bis (trialkoxysilylalkyl)amines, bis (dialkoxyalkylsilylalkyl)amine, bis (trialkoxysilylalkyl)N-alkylamine, bis (dialkoxyalkylsilylalkyl)N-alkylamine, bis (trialkoxysilylalkyl)urea and bis (dialkoxyalkylsilylalkyl) urea.

Specific suitable examples include example bis (3-trimethoxysilylpropyl)amine, bis (3-triethoxysilylpropyl)amine, bis (4-trimethoxysilylbutyl)amine, bis (4-triethoxysilylbutyl)amine, bis (3-trimethoxysilylpropyl)N-methylamine, bis (3-triethoxysilylpropyl)N-methylamine, bis (4-trimethoxysilylbutyl)N-methylamine, bis (4-triethoxysilylbutyl)N-methylamine, bis (3-trimethoxysilylpropyl)urea, bis (3-triethoxysilylpropyl)urea, bis (4-trimethoxysilylbutyl)urea, bis (4-triethoxysilylbutyl)urea, bis (3-dimethoxymethylsilylpropyl)amine, bis (3-diethoxymethyl silylpropyl)amine, bis (4-dimethoxymethylsilylbutyl)amine, bis (4-diethoxymethyl silylbutyl)amine, bis (3-dimethoxymethylsilylpropyl)N-methylamine, bis (3-diethoxymethyl silylpropyl)N-methylamine, bis (4-dimethoxymethylsilylbutyl)N-methylamine, bis (4-diethoxymethyl silylbutyl)N-methylamine, bis (3-dimethoxymethylsilylpropyl)urea, bis (3-diethoxymethyl silylpropyl)urea, bis (4-dimethoxymethylsilylbutyl)urea, bis (4-diethoxymethyl silylbutyl)urea, bis (3-dimethoxyethylsilylpropyl)amine, bis (3-diethoxyethyl silylpropyl)amine, bis (4-dimethoxyethylsilylbutyl)amine, bis (4-diethoxyethyl silylbutyl)amine, bis (3-dimethoxyethylsilylpropyl)N-methylamine, bis (3-diethoxyethyl silylpropyl)N-methylamine, bis (4-dimethoxyethylsilylbutyl)N-methylamine, bis (4-diethoxyethyl silylbutyl)N-methylamine, bis (3-dimethoxyethylsilylpropyl)urea bis (3-diethoxyethyl silylpropyl)urea, bis (4-dimethoxyethylsilylbutyl)urea and/or bis (4-diethoxyethyl silylbutyl)urea.

In a still further alternative the dipodal silanes (iid) are of the formula: (R⁴O)₃—Si(CH₂)ₓ—(NHCH₂CH₂)ₜ—NH(CH₂)ₓ—Si(OR⁴)₃, in which case the dipodal silane may be selected from a bis (trialkoxysilylalkyl) amine such as bis (3-tripropyloxysilypropyl)amine, bis (3-methyldiethoxysilypropyl)amine, bis (3-methyldimethoxysilypropyl)amine, bis (3-triethoxysilylpropyl)amine, bis (3-triethoxysilylpropyl)amine, bis (3-trimethoxysilylpropyl)amine, or may be a bis (trialkoxysilylalkyl) alkylenediamine such as N,N′-bis ((3-trimethoxysilyl)propyl]ethylenediamine.

The cross-linker may alternatively be a mixture of two or more (iia), (iib), (iic) and (iid). In one embodiment the cross-linker is a cross-linker having a (iic) structure alone or in combination with a cross-linker of type (iid).

Optionally, the catalyst package may also include one or more of,
(iii) a silyl modified organic polymer having at least two (R)ₘ(Y¹)₃₋ₘ—Si groups per molecule and/or
(iv) filler.

The optional silyl modified organic polymer having at least two (R)ₘ(Y¹)₃₋ₘ—Si groups per molecule (iii) has the same definition provided above for silyl modified organic polymers (a) described above and indeed may be, but is not restricted to being an additional amount of the same polymer as (a) above.

The filler (iv) in the catalyst part may be a reinforcing filler in accordance with (b) above or alternatively may be a non-reinforcing filler or a mixture thereof.

Suitable non-reinforcing fillers may comprise, for example, crushed quartz, ground calcium carbonate, diatomaceous earths, barium sulphate, iron oxide, titanium dioxide and carbon black, talc, wollastonite may be present in the composition. Other non-reinforcing fillers which might be used alone or in addition to the above include aluminite, calcium sulphate (anhydrite), gypsum, calcium sulphate, magnesium carbonate, clays such as kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite.

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅

The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂AI₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; A14[Si₄O₁₀](OH)₈; and vermiculite.

The non-reinforcing fillers may also be surface treated to be rendered hydrophobic using analogous treating agents as discussed for the reinforcing fillers above. In one embodiment optional filler (iv) in Part B of the composition herein is ground calcium carbonate, precipitated calcium carbonate, precipitated silica and/or fumed silica.

The content of each ingredient in the catalyst package at least partially depends on the predetermined ratio by weight of the two parts when they are inter-mixed immediately prior to use. Typically the base component composition and the catalyst package composition may be inter-mixed at a predetermined weight ratio of from 15:1 to 1:1, alternatively from 15:1 to 2:1; alternatively from 12:1 to 2:1 when the two parts are mixed together. If the intended mixing ratio by weight of the base component: catalyst package is 12:1 or greater i.e. between 15:1 and 12:1 then the contents of the catalyst package may be solely ingredients (i) (condensation catalyst) and (ii) (cross-linker) in which case the cross-linker is present in an amount of about 60 to 80% weight of the catalyst package and unless additives are present the catalyst is accordingly present in an amount of from 20 to 40% by weight of the total catalyst composition. However, in the event of the base composition and catalyst package being mixed at a weight ratio approaching 1:1 the bulk of the catalyst package is made up components (iii) polymer (a) and filler (iv) with small amounts of components (i) and (ii) present with a view that the final composition is the same. In such instances the condensation catalyst may be present in an amount of from 0.01 to 20 weight %; alternatively 0.1 to 5 weight % of the catalyst package and crosslinker (ii) in an amount of from 2-30% by weight of the catalyst composition, but generally from 2 to 15% by weight of the catalyst composition, alternatively from 4 to 11% by weight of the catalyst composition.

Other additives may be used if necessary. These may include pigments, rheology modifiers, plasticisers, anti-oxidants, heat stabilizers, flame retardants, UV stabilizers, water scavengers, (typically the same compounds as those used as cross-linkers or silazanes), cure modifiers, electrically conductive fillers, heat conductive fillers, and fungicides and/or biocides and the like; co-catalysts for accelerating the cure of the composition such as metal salts of carboxylic acids and amines. It will be appreciated that some of the additives are included in more than one list of additives. Such additives would then have the ability to function in all the different ways referred to.

Pigments are utilized to color the composition as required. Any suitable pigment may be utilized providing it is compatible with the composition. In two-part compositions pigments and/or colored (non-white) fillers, e.g. carbon black may be utilized in the catalyst package to color the end adhesive product. When present carbon black will function as both a non-reinforcing filler and colorant and is present in a range of from 1 to 30% by weight of the catalyst package composition, alternatively from 1 to 20% by weight of the catalyst package composition; alternatively from 5 to 20% by weight of the catalyst package composition, alternatively from 7.5 to 20% by weight of the catalyst composition.

Rheology modifiers which may be incorporated in moisture curable compositions according to the invention include silicone organic co-polymers such as those described in EP0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion to substrates, particularly plastic substrates.

Plasticisers are often utilised in silyl modified organic polymer based compositions. Given the fact that the polymer backbone is substantially organic (i.e. not containing Si—O—Si bonds in the polymer backbone) the plasticisers are generally selected from those which are suitable for plasticizing the polymer(s) (a) and (iii) if the latter is present. Examples include hydroxyl terminated polypropylene ethers, hydroxyl terminated polyethylene ethers, hydroxyl terminated polypropylene/polyethylene ether co-polymers. Alkoxy terminated polypropylene ethers, alkoxy terminated polyethylene ethers, alkoxy terminated polypropylene/polyethylene ether co-polymers. Commercially hydroxyl terminated polypropylene ethers are sold under the VORANOL Trade Mark by the Dow Chemical Company.

Any suitable anti-oxidant(s) may be utilised, if deemed required. Examples may include: ethylene bis (oxyethylene) bis(3-tert-butyl-4-hydroxy-5(methylhydrocinnamate) 36443-68-2; tetrakis[methylene(3,5-di-tert-butyl-4-hydroxy hydrocinnamate)]methane 6683-19-8; octadecyl 3,5-di-tert-butyl-4-hydroxyhyrocinnamate 2082-79-3; N,N′-hexamethylene-bis (3,5-di-tert-butyl-4-hydroxyhyrocinnamamide) 23128-74-7; 3,5-di-tert-butyl-4-hydroxyhydrocinnamic acid, C7-9 branched alkyl esters 125643-61-0; N-phenylbenzene amine, reaction products with 2,4,4-trimethylpentene 68411-46-1; e.g. anti-oxidants sold under the Irganox® name from BASF.

Biocides may additionally be utilized in the composition if required. It is intended that the term “biocides” includes bactericides, fungicides and algicides, and the like. Suitable examples of useful biocides, which may be utilized in compositions as described herein, include, for the sake of example:

Carbamates such as methyl-N-benzimidazol-2-ylcarbamate (carbendazim) and other suitable carbamates, 10,10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyl)pentan-3-ol and/or 1-[[2-(2,4-dichlorophenyl)-4-propyl-1,3-dioxolan-2-yl] methyl]-1H-1,2,4-triazole.

The fungicide and/or biocide may suitably be present in an amount of from 0 to 0.3% by weight of the composition and may be present in an encapsulated form where required such as described in EP2106418.

Heat stabilizers may include Examples of heat stabilizers include metal compounds such as red iron oxide, yellow iron oxide, ferric hydroxide, cerium oxide, cerium hydroxide, lanthanum oxide, copper phthocyanine, aluminium hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like.

Flame retardants may include for example, carbon black, hydrated aluminium hydroxide, and silicates such as wollastonite, platinum and platinum compounds.

UV stabilisers may include, for the sake of example include benzotriazole ultraviolet light absorbers and/or hindered amine light stabilizers (HALS) such as the TINUVIN® product line from Ciba Specialty Chemicals Inc.

Electrically conductive fillers may include carbon black, metal particles such as silver particles any suitable, electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium.

Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO); magnesium oxide, zinc oxide, zirconium oxide; Ceramic fillers such as tungsten monocarbide, silicon carbide and aluminium nitride, boron nitride and diamond.

In the case of 2 part compositions, the base component comprises: 20 to 80 weight %, alternatively from 35 to 65% by weight of silyl modified organic polymer (a); and 20 to 80 weight %, alternatively from 35 to 65% by weight of reinforcing fillers (b); with the total weight % of the base component being 100 weight %.

The additives may be introduced into either part A or part B of the composition as preferred. For example, plasticisers, anti-oxidants, UV stabilizers and/or pigments are most likely to be introduced into part A but may alternatively be present in the part B composition.

In said 2 part composition the catalyst package, Part B typically comprises
condensation cure (e.g. tin) based catalyst (i) in an amount of 0.5 to 40 weight % based on the weight of the catalyst package;
cross-linker (ii) in an amount of 1 to 80 weight %, based on the weight of the catalyst package; and optionally
silyl modified organic polymer having at least two (R)ₘ(Y¹)₃₋ₘ—Si groups per molecule (iii) in an amount of 0 to 98.5 weight % based on the weight of the catalyst package and and/or
filler in an amount of 0 to 40% by weight based on the weight of the catalyst package; wherein the total weight of the catalyst package is 100% by weight.

The final composition when part A and part B have been mixed together is typically along the following lines based on the weight of the combined composition:
18 to 72 weight %, alternatively 35 to 67% by weight of SMP polymer (a);
18 to 63 weight %, alternatively 25 to 50% by weight of reinforcing fillers (b);
Condensation catalyst (i) in an amount of 0.5 to 5 weight %;
cross-linker (ii) in an amount of 1 to 15 weight %, alternatively 2 to 10 weight %; based; and optionally
filler from the catalyst package in an amount of 0 to 40% by weight; and
If required other optional ingredients

The compositions are preferably room temperature vulcanisable compositions in that they cure at room temperature without heating, but may if deemed appropriate be accelerated by heating

The compositions of part A and part B can be prepared by mixing the ingredients employing any suitable mixing equipment. Other additional optional components may be added in either part A or Part B as deemed appropriate.

After mixing, the compositions of part A and part B, especially of part B, may be stored under substantially anhydrous conditions, for example in sealed containers, until required for use.

There is also provided a lamp having a lamp body defining a lamp chamber containing a light source and having a front opening, a front lens is provided to engage into the front opening, said front lens having an inner surface and an outer surface, with said inner surface further defining the lamp chamber, the inner surface being coated with an anti-haze coating characterised in that the front lens is adhered to the lamp chamber by a cured adhesive made from a two-part condensation curable SMP based adhesive composition comprising a first part, Part A, which comprises
(a) a silyl modified organic polymer having at least two (R)ₘ(Y)₃₋ₘ—Si groups per molecule where each R is hydroxyl or a hydrolysable group, each Y¹ is an alkyl group containing from 1 to 8 carbons and m is 1, 2 or 3, which organic polymer is selected from polyethers, hydrocarbon polymers, acrylate polymers, polyesters, polyurethanes and polyureas;
   and
(b) a reinforcing filler
   and
   a catalyst package, Part B comprising
(i) a tin based catalyst, and
(ii) a cross-linker selected from the group of:—
   (iia) a silane of the structure

R⁶ⱼSi(OR⁵)₄₋ⱼ

where each R⁵ may be the same or different and is an alkyl group containing at least 2 carbon atoms;
j is 1 or 0; and
R⁶ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group;
(iib) a silane of the structure

R⁷Si(OMe)₃

wherein R⁷ is R⁶ providing the molecular weight of said silane (iib) is ≥190;
(iic) a silane of the structure

(R′O)₃Si(CH₂)ₙN(H)—(CH₂)_{z}NH₂

in which each R′ may be the same or different and is an alkyl group containing from 1 to 10 carbon atoms, n is from 2 to 10 and z is from 2 to 10;
(iid) a dipodal silane of the structure

(R⁴O)ᵣ(Y²)₃₋ᵣ—Si(CH₂)ₓ—((NHCH₂CH₂)ₜ-Q(CH₂)ₓ)_{w}—Si(OR⁴)r(Y²)₃₋ᵣ

where R⁴ is a C1-10 alkyl group, Y² is an alkyl groups containing from 1 to 8 carbons,
Q is a chemical group containing a heteroatom with a lone pair of electrons; each x is an integer of from 1 to 6, t is 0 or 1; each r is independently 1, 2 or 3 and w is 0 or 1, or
(iie) a mixture of two or more of (iia), (iib), (iic) and (iid); and optionally
(iii) silyl modified organic polymer having at least two (R)ₘ(Y¹)₃₋ₘ—Si groups per molecule (a) and/or
(iv) filler.

The lamp body may be made of any suitable material such as Polybutylene terephthalate (PBT), Cast Aluminum, Acrylonitrile butadiene styrene (ABS), polypropylene (PP), ethylene propylene diene monomer rubber (EPDM), Polyphenylene sulfide (PPS), Polyether ether ketone (PEEK), low density polyethylene (LDPE), high density polyethylene (HDPE), polyamide (PA), Acrylic-styrene-acrylonitrile (ASA), Polyether ether ketone (PEEK) and composites thereof. PBT-GF30 (a polybutylene terephthalate that contains fibreglass), TV40+PP and TV20/GF10, PBT-MF30, blend of Polybutylene Terephthalate and Acrylonitrile Styrene Acrylate (PBT/ASA) and PP+GF20 (glass fibre reinforced PP).

The front lens may be made of any suitable material, specific examples include but are not limited to polycarbonate or PMMA or the like.

The outer surface of the lens may be treated with a scratch resistant coating.

There is also provided a method for making the aforementioned lamp including the steps of providing a lamp body having a front opening and a front lens, said front lens having at least an inner surface treated with an anti-haze coating, forming a joint between the front lens into the front opening of the lamp body by engaging the front lens into the front opening of the lamp body and sealing the joint between the front lens and the lamp body with an adhesive as hereinbefore described by mixing part A and part B of the adhesive composition together to form a mixture, applying the mixture onto the joint between the front lens and the lamp body and causing or allowing the composition to cure; wherein said adhesive is a two-part condensation curable silicone based adhesive composition comprising

a first part, Part A, which comprises
(a) a silyl modified organic polymer having at least two (R)ₘ(Y¹)₃₋ₘ—Si groups per molecule where each R is hydroxyl or a hydrolysable group, each Y¹ is an alkyl group containing from 1 to 8 carbons and m is 1, 2 or 3, which organic polymer is selected from polyethers, hydrocarbon polymers, acrylate polymers, polyesters, polyurethanes and polyureas;
   and
(b) a reinforcing filler
and
   a catalyst package, Part B comprising
(i) a condensation catalyst, and
(ii) a cross-linker selected from the group of:—
   (iia) a silane of the structure

R⁶ⱼSi(OR⁵)₄₋ⱼ

where each R⁵ may be the same or different and is an alkyl group containing at least 2 carbon atoms;
j is 1 or 0; and
R⁶ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group;
(iib) a silane of the structure

R⁷Si(OMe)₃

wherein R⁷ is R⁶ providing the molecular weight of said silane (iib) is ≥190;
(iic) a silane of the structure

(R′O)₃Si(CH₂)ₙN(H)—(CH₂)_{z}NH₂

in which each R′ may be the same or different and is an alkyl group containing from 1 to 10 carbon atoms, n is from 2 to 10 and z is from 2 to 10;
(iid) a dipodal silane of the structure

(R⁴O)ᵣ(Y²)₃₋ᵣ—Si(CH₂)ₓ—((NHCH₂CH₂)ₜ-Q(CH₂)ₓ)_{w}—Si(OR⁴)ᵣ(Y²)₃₋ᵣ

where R⁴ is a C1-10 alkyl group, Y² is an alkyl groups containing from 1 to 8 carbons,
Q is a chemical group containing a heteroatom with a lone pair of electrons; each x is an integer of from 1 to 6, t is 0 or 1; each r is independently 1, 2 or 3 and w is 0 or 1, or
(iie) a mixture of two or more of (iia), (iib), (iic) and (iid); and optionally
(iii) silyl modified organic polymer having at least two (R)ₘ(Y¹)₃₋ₘ—Si groups per molecule (a) and/or
(iv) filler;
   and which two part formulation is mixed together shortly before application.

The process may involve fitting and engaging a lamp lens into a front opening of a lamp chamber; mixing the part A and part B compositions in a pre-determined ratio e.g. part A:Part B being between 15:1 and 1:1, e.g. about 10:1. The resulting adhesive composition can then be applied onto the space/join between said front lens engaged in the front opening of the lamp chamber and the lamp chamber and causing or allowing the composition to cure thereby sealing said join between the front lens and the lamp chamber.

The process may also include a step of applying a coating of an anti-haze coating composition onto at least one surface of the front lens, i.e. the inner surface. The coating is applied so as to have a thickness, when dry/cured of between 1 to 100 μm.

Adhesives as described above may be utilised in a variety of applications, for example outdoor lighting, decorative lighting, vehicle lamps e.g. for automobile, truck, motorcycle and boat lamps, as well as other vehicle lamps, lighting applications and indeed any other applications requiring a condensation cure adhesive with by-products having a low-volatile content, e.g. for sealing housings/boxes of electronic components. Vehicle lamps may include for the sake of example head lamps, brake lamps, running lamps, turn signal lamps, fog lamps, back-up lamps and parking lamps.

### EXAMPLES

All viscosities mentioned were measured at 25° C. using a Brookfield HAF viscometer using spindle No. 3 at 10 rpm.

A series of examples have been prepared and are compared with a two part reference material. The formulation of the two part reference material is depicted in Tables 1a and 1b below:

TABLE 1a
Reference Part A Composition

| | Weight % of Part A |
|---|---|
| Part A Ingredients | Ingredients |
| Dimethyl hydroxy terminated polydimethylsiloxane, | 58.33 |
| viscosity 16,500 mPa · s at 25° C. | |
| Precipitated Calcium Carbonate | 40.19 |
| Titanium dioxide | 1.48 |

The calcium carbonate used was a stearic acid treated commercially available calcium carbonate sold under the name Calofort® SM EA from Specialty Minerals Inc.

TABLE 1b
Reference Catalyst Package

| | Comp. 1 |
|---|---|
| Ingredients | (wt. %) |
| Trimethylsilyl terminated polydimethylsiloxane | 56.89 |
| 60,000 mPa · s | |
| Carbon black | 13 |
| Treated silica | 0.65 |
| Dimethyltindineodecanoate (DMDTN) catalyst | 0.23 |
| reaction product of aminopropyltrimethoxysilane | 25.06 |
| with glycidoxypropyltrimethoxysilane and | |
| methyltrimethoxysilane | |
| methyltrimethoxysilane | 4.18 |

The treated silica used in the catalyst package was AEROSIL® 974 from Evonik. The Reference composition was mixed in a Part A: Part B weight ratio of 13:1.

A series of examples in accordance with the composition described herein have been prepared and tested. The compositions are provided in Tables 2a and 2b below.

TABLE 2a
Examples Part A compositions

| | Ex. | Ex. | Ex. | Ex. | Ex. |
|---|---|---|---|---|---|
| Part A Ingredients | 1 | 2 | 3 | 4 | 5 |
| Treated precipitated | 50% | 57% | 57% | 50% | 41% |
| CaCO₃ | | | | | |
| Branched | 45.7% | | | 45.7% | |
| trimethoxysilane | | | | | |
| terminated polyether, | | | | | |
| without Urethane bond | | | | | |
| viscosity of 40,000 | | | | | |
| mPa · s at 25° C. | | | | | |
| triethoxysilane | | 24% | | | |
| terminated | | | | | |
| polyether with Urethane | | | | | |
| bond viscosity of 13,000 | | | | | |
| mPa · s at 25° C. | | | | | |
| Branched | | | 34% | | |
| dimethoxymethylsilane | | | | | |
| terminated polyether | | | | | |
| without Urethane bond | | | | | |
| viscosity of 12,000 | | | | | |
| mPa · s at 25° C. | | | | | |
| Acrylic modified MS | | | | | 54.5% |
| polymer | | | | | |
| VORANOL ™ 3003LM | 4% | 18.5% | 8.5% | 4% | 4% |
| (plasticizer) | | | | | |
| Irganox ®1135 Anti- | 0.2% | 0.5% | 0.5% | | |
| oxidant | | | | | |
| Irganox ®1076 Anti- | | | | 0.2% | 0.5% |
| oxidant | | | | | |
| 1,6-Bis(trimethoxysilyl)- | 0.1% | | | 1% | |
| hexane | | | | | |

VORANOL™ 3003LM is a hydroxyl terminated polypropylene ether from the Dow Chemical Company. The, Irganox® 1135 and Irganox® 1076 anti-oxidants are commercially available anti-oxidants from BASF. The reference to with and without urethane bond is the equivalent of k being 1 (with) and 0 (without) regarding the urethane bond described previously and provided below

(R)ₘ(Y¹)₃₋ₘ—Si-D-[NH—C(═O)]ₖ—

TABLE 2b
Examples Part B compositions

| | Ex. | Ex. | Ex. | Ex. | Ex. |
|---|---|---|---|---|---|
| Part B Ingredients | 1 | 2 | 3 | 4 | 5 |
| Branched | 62% | | 91% | 66% | 93% |
| Trimethoxysilane terminated | | | | | |
| polyether, without Urethane bond | | | | | |
| viscosity 40,000 mPa · s at 25° C. | | | | | |
| Trimethoxysilane terminated | | 91% | | | |
| polyether, with Urethane bond, | | | | | |
| viscosity 40,000 mPa · s | | | | | |
| at 25° C. | | | | | |
| Ground calcium carbonate | 30% | | | 30% | |
| (ethylenediaminepropyl) | 5% | 4% | 4% | 3% | 4% |
| trimethoxysilane | | | | | |
| 1,6-Bis(trimethoxysilyl)-hexane | | 1% | 1% | | 1% |
| Dimethyltin Dineodecanoate | 3% | 4% | 4% | | |
| Dibutyltin Dilaurate | | | | 1% | |
| Dibutyltin Bis(2,4-pentanedionate) | | | | | 2% |

The example 1, 4 and 5 compositions were mixed in a Part A: Part B weight ratio of 10:1. The example 2 and 3 compositions were mixed in a Part A: Part B weight ratio of 3:1. In all instances, i.e. both Reference and Examples both the part A and Part B compositions were individually prepared using a speed mixer at 23° C. and 50% relative humidity in each case for a period of 40 seconds at 2000 revolutions per minute (rpm). The pre-mixed Part A and Part B composition were mixed together in a speed mixer in the ratios indicated above under the same conditions again for a period of 40 seconds at 2000 rpm.

The above compositions were assessed for their physical properties as depicted in Table 3 below. A test was developed to measure the effect of the by-products and volatiles from the adhesive compositions in an enclosed space on anti-haze coatings. Substrates were coated with a commercial anti-haze coating. The test protocol is described below and was used for all examples and comparative examples.

### Antihaze Coating (AHC) Compatibility Test Method—to Determine the Compatibility of a Silicone Adhesive to Two Commercial Anti-Haze Coatings (AHCs).

For the avoidance of doubt compatibility with respect to this test was intended to mean the determination as to whether or not the water-film-forming-effect intended by the provision of a commercially available AHC on an internal closed surface of a sample piece is changed by the by-products and residual cross-linker materials from the silicone adhesive.

The SMP adhesive under test was first prepared by mixing part A and part B in a ratio of part A:part B of 10:1, using a speed mixer. Once mixed approximately 1.0 g of the resulting uncured adhesive product was placed on the bottom of an Alu-Cup (Alu-Kappen Art.-Nr. 3621313 (32×30 mm), from SCHUETT-BIOTEC GMBH (hereafter referred to as “Alu-Cup”). The open end of the Alu-cup was then covered and closed by placing a polycarbonate (PC) plate, which had been previously coated with an anti-haze coating thereon, ensuring full closure. The PC plate was fixed in place ensuring that the Silicone Adhesive and the AHC share the same atmosphere for a typical cure time of the Silicone Adhesive. The Alu-Cups were then left for a 7 day period to allow the adhesive to thoroughly cure. It is to be understood that during the cure process, given it is by way of a condensation cure process by-products and residual cross-linker will evaporate into the atmosphere within the cup and may contaminate and effect the AHC on the inner facing surface of the polycarbonate strip.

After the 7 day cure period, a 2nd Alu-Cup, was filled with water and heated on a laboratory hotplate up to 75° C. The PC plate was then removed from the original Alu-Cup and placed onto the opening of the second Alu-Cup with the AHC coating facing the water therein. The interaction between the hot water and the AHC coated surface was then observed to determine the effectiveness of the AHC with respect to hazing/fogging. So that the reaction of the AHC to the heated water when the AHC is in contact with water steam and its water-film-forming property can be evaluated

1. This analysis was carried out for a 30 s period. As an alternative to observation the results may be photographed. The observation may be recorded by camera or video.
2. The samples were then ranked as follows:—
a. Hazy surface, alu-cup-bottom not visible=>AHC fully contaminated
b. Clear surface, alu-cup-bottom not visible, fine water drops=>AHC is contaminated
c. Clear surface, alu-cup-bottom visible, large water drops=>AHC might be contaminated
d. Clear surface, alu-cup-bottom visible, water film=>AHC is not contaminated
3. Silicone Adhesives which are ranked with (c) and (d) (Pass criteria) can be rated as compatible.

A series of standard physical property test were undertaken to ensure the adhesive had the necessary physical properties to function as an adhesive. The results thereof, together with details of the standard test methods followed are also depicted in Table 3.

Snap time is measured by gently touching at regular time intervals (typically 2-3 min) a spatula on the surface of the curing composition. As the cure progresses, the coating gains viscosity and elasticity. When these two are sufficiently high, the coating “snaps off” the spatula. The time elapsed between the casting of the coating and the first observation of the snap-off effect is recorded as snap time. This value has practical importance, because it provides an indication about the working time of the coating. The working time is defined as the time which the applicator is able to work with the material before the latter reaches a state of sufficiently high viscosity which prevents it from being properly handled and tooled. Snap time is used as a rough estimation of the working time. In this case base 2 was mixed with the catalyst package for the measurement of snap time.

Lap shear testing was also undertaken as described below

Lap shear Tensile Strength
Sample coupons sized 1 mm×25 mm×100 mm were cleaned with isopropyl alcohol and then cleaned via plasma treatment prior to testing.

Samples of the composition (Part A+Part B) sufficient to fill a 25 mm overlap with a minimum bond thickness of 0.76 were applied onto a pre-cleaned first substrate coupon (polypropylene) surface in a laminating apparatus. A second substrate coupon (a previously plasma treated polycarbonate) was then placed on top of the composition applied to the first substrate to give a pre-sized lap. The two substrates were compressed and excess composition was removed. The samples of composition in said pre-sized laps sandwiched between the two substrates were cured at room temperature for a period of seven days after which the lap shear tensile strength was determined by pulling the pre-sized laps apart by shear rather than peel (1800 pull) at a rate of 2.0 cm/min using an Instron® 3366 apparatus.

Cohesive failure (CF) is observed when the cured elastomer/adhesive itself breaks without detaching form the substrate surface. It was considered that if the failure was not by CF it was by adhesive failure (AF). Adhesive failure (AF) refers to the situation when a sample detaches cleanly (peels off) from a substrate surface. In some cases a mixed failure mode has been observed: i.e. some areas peel-off (i.e. AF) while some remain covered with cured elastomer/adhesive i.e. CF). In such instances the portion displaying CF (% CF) is recorded (bearing in mind % CF+% AF=100%).

TABLE 3
Properties of Compositions/elastomers made by mixing the respective Part A and Part B compositions
Base (Table 1 and the catalyst package of Table 2 post mixing in a 10:1 ratio

| Properties | Ex. 1 | Ex. 2 | Ex. 3 | Ex. 4 | Ex. 5 | Control |
|---|---|---|---|---|---|---|
| Commercial AHC 1 compatibility | Clear no | clear no | clear no | clear no | clear no | Very Hazy |
| 7 days @ room temperature (RT) | water drops | water drops | water drops | water drops | water drops | many water |
| | | | | | | drops |
| Snap Time (min) | 19 | 40 | 42 | 8.5 | 8 | 8 |
| Lap Shear Strength (MPa) (ASTM | 2.08 | 1.49 | 1.58 | 1.66 | 3.11 | 1.98 |
| D3163) | | | | | | |
| Adhesion on PC CF % (ASTM D3163) | 10 | 80 | 100 | 10 | 0 | 100 |
| Adhesion on PP CF % (ASTM D3163) | 100 | 100 | 100 | 100 | 100 | 100 |
| Tensile Strength (Dogbone, MPa) | 2.03 | 1.68 | 1.88 | 1.802 | 3.263 | 1.75 |
| (ASTM D412-98a) | | | | | | |
| Elongation at break (Dogbone, %) | 390 | 264 | 297 | 283.29 | 147.755 | 286 |
| (ASTM D412-98a) | | | | | | |
| Modulus at 100% (MPa) (ASTM | 1.28 | 0.87 | 0.987 | 1.121 | 2.4 | 0.96 |
| D412-98a) | | | | | | |
| Shore A Hardness (ASTM D2240-97) | 42.8 | 33.7 | 38.5 | 43 | 49.3 | 35.9 |

It was found that the reference material when used in the anti-haze test failed as the anti-haze coating under test had many visible water drops on the surface and also gave a very hazy view. However, in each case the Examples as described herein all provide a transparent anti-haze coating with no droplets and as such can be interpreted not to negatively affect the anti-haze coating. Furthermore the physical properties of the examples showed good results and indicate that the different examples tested were all potential lamp adhesives which post-cure did not release by products/cross-linker which negatively interacted with the anti-haze coating thereby enabling the anti-haze coating to function.

1. A two-part condensation curable silyl-modified polymer based adhesive composition comprising a base part, Part A, and a catalyst package, Part B, wherein part A comprises:
(a) a silyl modified organic polymer having at least two (R)ₘ(Y¹)₃₋ₘ—Si groups per molecule
where each R is a hydroxyl or a hydrolysable group, each Y¹ is an alkyl group containing from 1 to 8 carbons, and m is 1, 2, or 3, and where the organic polymer is selected from the group consisting of polyethers, hydrocarbon polymers, acrylate polymers, polyesters, polyurethanes and polyureas; and
(b) a reinforcing filler;
and
wherein Part B comprises:
(i) a tin based catalyst; and
(ii) a cross-linker selected from the group consisting of:—
(iia) a silane of the structure
R⁶ⱼSi(OR⁵)₄₋ⱼ
where each R⁵ is an independently selected alkyl group containing at least 2 carbon atoms; j is 1 or 0; and R⁶ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group;
(iib) a silane of the structure
R⁷Si(OMe)₃
wherein Me is CH₃ and R⁷ is R⁶ providing the molecular weight of the silane (iib) is ≥190;
(iic) a silane of the structure
(R′O)₃Si(CH₂)ₙN(H)—(CH₂)_{z}NH₂
where each R′ is an independently selected alkyl group containing from 1 to 10 carbon atoms, n is from 2 to 10, and z is from 2 to 10;
(iid) a dipodal silane of the structure
(R⁴O)ᵣ(Y²)₃₋ᵣ—Si(CH₂)ₓ—((NHCH₂CH₂)ₜ-Q(CH₂)ₓ)_{w}—Si(OR⁴)ᵣ(Y²)₃₋ᵣ
where each R⁴ is a C1 to C10 alkyl group, each Y² is an alkyl group containing from 1 to 8 carbon atoms, Q is a chemical group containing a heteroatom with a lone pair of electrons; each x is an integer of from 1 to 6, and t is 0 or 1; each r is independently 1, 2 or 3, and w is 0 or 1, or
(iie) a mixture of two or more of (iia), (iib), (iic) and (iid); and optionally
(iii) a silyl modified organic polymer having at least two (R)ₘ(Y¹)₃₋ₘ—Si groups per molecule, and/or
(iv) a filler.

2. The two-part condensation curable silyl-modified polymer based adhesive composition in accordance with claim 1, wherein the reinforcing filler (b) in Part A is a precipitated calcium carbonate and the optional filler (iv) in Part B is ground calcium carbonate, precipitated calcium carbonate, precipitated silica, and/or fumed silica.

3. The two-part condensation curable silyl-modified polymer based adhesive composition in accordance with claim 1, wherein the tin based catalyst (i) in Part B is a tin catalyst selected from the group consisting of a tin triflate, triethyltin tartrate, tin octoate, tin oleate, tin naphthate, butyltintri-2-ethylhexoate, tin butyrate, carbomethoxyphenyl tin trisuberate, isobutyltintriceroate, dibutyltin dilaurate, dimethyltin dibutyrate, dibutyltin dimethoxide, dibutyltin diacetate, dimethyltin bisneodecanoate, dibutyltin dibenzoate, stannous octoate, dibutyltin bis 2,4-pentanedionate, dimethyltin dineodecanoate, and dibutyltin dioctoate.

4. The two-part condensation curable silyl-modified polymer based adhesive composition in accordance with claim 1, wherein the polymer (a) in Part A is a polyether terminated with
(R)ₘ(Y¹)₃₋ₘ—Si-D-[NH—C(═O)]ₖ—
where each R is a hydroxyl or a hydrolysable group, each Y¹ is an alkyl group containing from 1 to 8 carbons, m is 1, 2, or 3, D is a divalent C₂₋₆ alkylene group, and k is 1 or 0.

5. The two-part condensation curable silyl-modified polymer based adhesive composition in accordance with claim 1, wherein the cross-linker (ii) in Part B is either cross-linker (iic) or a mixture of cross-linkers (iic) and (iid).

6. The two-part condensation curable silyl-modified polymer based adhesive composition in accordance with claim 1, wherein a pigment/non-reinforcing filler is present in Part B in an amount of from 1 to 30% by weight of Part B.

7. The two-part condensation curable silyl-modified polymer based adhesive composition in accordance with claim 1, wherein Part B comprises:
the tin based catalyst (i) in an amount of from 0.5 to 40 weight %;
the cross-linker (ii) in an amount of from 1 to 80 weight %;
the silyl modified organic polymer (iii) in an amount of from 0 to 98.5 weight %; and
the filler (iv) in an amount of from 0 to 40% by weight; with the total weight of Part B being 100% by weight.

8. The two-part condensation curable silyl-modified polymer based adhesive composition in accordance with claim 1, wherein Part A and Part B are inter-mixed in a weight ratio of from 15:1 to 1:1.

9. A lamp having a lamp body defining a lamp chamber containing a light source and having a front opening, and a front lens to engage into the front opening, the front lens having an inner surface and an outer surface, with the inner surface further defining the lamp chamber, the inner surface being coated with an anti-haze coating, wherein the front lens is adhered to the lamp chamber by a cured adhesive formed from the two-part condensation curable silyl-modified polymer based adhesive composition in accordance with claim 1.

10. The lamp in accordance with claim 9, wherein the lamp body is made from polybutylene terephthalate, cast aluminum, acrylonitrile butadiene styrene, polypropylene, ethylene propylene diene monomer rubber, polyphenylene sulfide, polyether ether ketone or a composite thereof, low density polyethylene, high density polyethylene, polyamide, acrylic-styrene-acrylonitrile, or polybutylene terephthalate or a composite thereof.

11. The lamp in accordance with claim 9, wherein the front lens is made from polycarbonate or poly(methyl methacrylate).

12. The lamp in accordance with claim 9, wherein the outer surface of the front lens is treated with a scratch resistant coating.

13. A method for making the lamp in accordance with claim 9, the method including the steps of: providing the lamp body and the front lens; engaging the front lens into the front opening of the lamp body to form a joint; and sealing the joint between the front lens and the lamp body with the adhesive composition by mixing Part A and Part B together to form a mixture, applying the mixture onto the joint between the front lens and the lamp body, and causing or allowing the adhesive composition to cure.

14. The lamp in accordance with claim 9, further defined as at least one of an outdoor light, a decorative light, or a vehicle lamp.

15. The lamp in accordance with claim 14, further defined as a vehicle lamp selected from the group consisting of headlamps, brake lamps, running lamps, turn signal lamps, fog lamps, back-up lamps, and parking lamps.

16. An adhesive comprising the reaction product of the two-part condensation curable silyl-modified polymer based adhesive composition in accordance with claim 1.
